(19) United States
(12) Patent Application Publication
(10) Pub. No.: US 2011/0142375 A1
(43) Pub. Date: Jun. 16, 2011

(54) LOCKING MEDICINE BAG

(75) Inventor: Susan Morse Lebow, Los Angeles, CA (US)

(73) Assignee: BETTER OFF SAFE, LLC, Los Angeles, CA (US)

(21) Appl. No.: 12/635,434

(22) Filed: Dec. 10, 2009

(51) Int. Cl. B65D 33/16; B65D 83/04; E05B 65/52; E05B 37/02

(52) U.S. Cl. 383/64; 206/528; 70/64; 70/332

(57) ABSTRACT

A locking medicine bag is disclosed that includes a casing having an exterior surface and an interior surface. There is a zipper disposed on at least one side of the casing having a zipper slider connected to first and second half zipper tracks. A zipper handle is connected to the zipper slider, and the zipper handle includes a hook member extending from one side of the zipper handle. The zipper handle and hook member are a single molded piece. Further, there is a combination lock secured along one side of the casing. The combination lock includes an exterior plate having a slot that exposes a latch member. The slot is sized to receive the hook member of the zipper handle, and the hook member engages the latch member in a locked configuration.

### BACKGROUND OF THE INVENTION

This invention relates to a locking medicine bag. More particularly, this invention relates to a bag for storing drugs that includes a locking zipper to impede opening of the bag.

In general, drugs or medications are stored in a medicine cabinet and are accessible by anyone in the home, including children. It has always been a problem that children gain possession of drugs stored in medicine cabinets and even ingest these drugs that may be a harmful to the child. Further, drugs stored in a purse, bag, suitcase, or the like, are also easy accessible by children and others.

The use of a locked medicine cabinet is well known as a way to secure drugs in the home to prevent children and others from gaining access to the drugs. However, drugs that are carried on a person or taken on trips away from the home are not secured in the medicine cabinet, and therefore, children and others may gain possession of the drugs in these situations.

### SUMMARY OF THE DISCLOSURE

The invention includes a locking medicine bag having a casing with an interior surface and an exterior surface. In one embodiment, the casing has generally six sides, however, the casing may take a more rounded shaped. There is a zipper disposed on at least one side of the casing having a first half zipper track and a second half zipper track. Also, a zipper slider is connected to the first and second half zipper tracks for engaging and disengaging the first and second half zipper tracks into open and closed configurations. A zipper handle is connected to the zipper slider and the zipper handle includes a hook member extending from one side of the zipper handle. The zipper handle and hook member are a single molded piece in one embodiment. The locking medicine bag also includes a combination lock secured along one side of the casing. An exterior plate of the combination lock includes a slot that exposes a latch member disposed within the combination lock. The slot is sized to receive the hook member of the zipper handle, and the hook member engages the latch member in a locked configuration.

The locking medicine bag may also include a rib disposed along the casing to provide support. In one embodiment, the casing is formed of a soft and flexible material. The ribbing may also be disposed between sides of the casing. In one embodiment, the interior surface of the casing includes loops or pockets to secure objects such as medicine or prescription bottles. The loops may be formed by an elastic strap. In other embodiments, there are no loops or pockets and medicine or prescription bottles are placed within the interior of the locking medicine bag.

In use, drugs or other objects are placed within the locking medicine bag and then the zipper of the locking medicine bag is zipped closed with the zipper handle. Once the zipper is closed, the hook member may be placed within the slot of the combination lock. As the hook member slides within the slot of the combination lock, the latch member of the combination lock engages the hook member and locks it into place. There are three combination dials on the combination lock that may then be randomly moved to prevent another from opening the locking medicine bag. To open the locking medicine bag, the three combination dials are moved to a set combination and then an actuator is activated to disengage the latch member from the hook member. This allows the zipper handle to be moved away from the combination lock and the zipper to be unzipped and the contents stored in the locking medicine bag to be removed.

### BRIEF DESCRIPTION OF THE DRAWINGS

FIG. 1 depicts a perspective view of a medicine bag in a locked configuration;

FIG. 2 depicts a perspective view of the medicine bag of FIG. 1 in an unlocked configuration;

FIG. 3 depicts a side elevational view of the medicine bag of FIG. 1 with the zipper closed; and

FIG. 4 depicts a side elevational view of the medicine bag of FIG. 1 with the zipper open.

### DETAILED DESCRIPTION

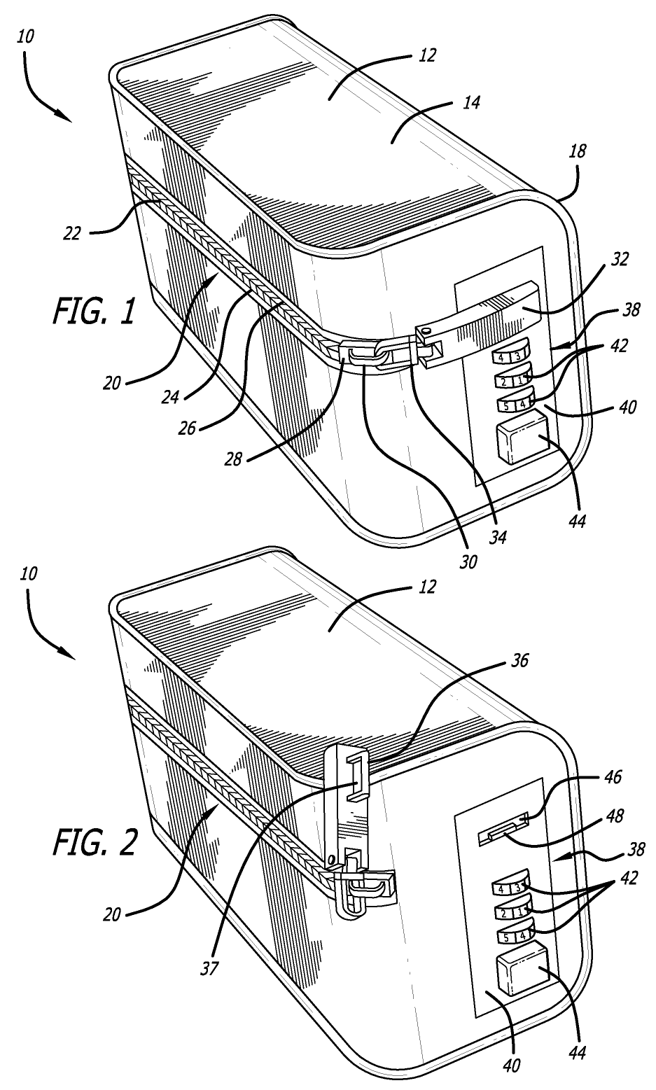

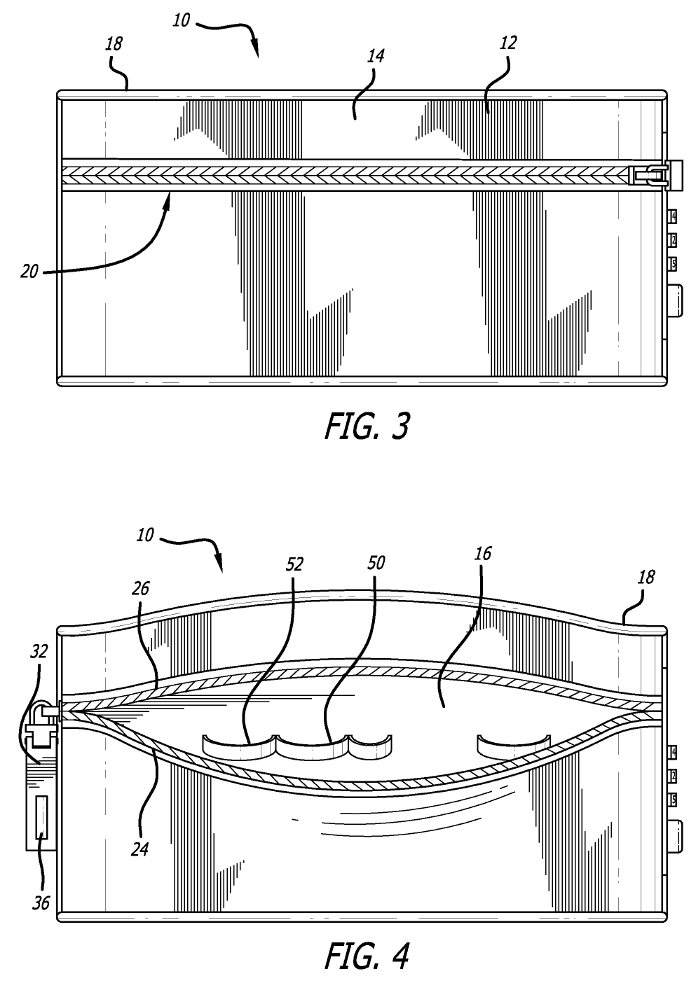

Turning now to the figures, which are provided by way of example and not limitation, the disclosed embodiment is a locking bag for storing drugs such as medications. Moreover, the disclosed embodiment can also store anything that a user wants to keep safe or out of reach of children and others. Referring now to the drawings, wherein like reference numerals denote like or corresponding components throughout the drawings and, more particularly to FIGS. 1-4, there is shown an embodiment of a locking medicine bag.

FIG. 1 shows a locking medicine bag 10 in a locked or closed configuration. The bag includes a casing 12 having an exterior surface 14 and an interior surface 16 (shown in FIG. 4). In one embodiment, the casing is soft and flexible. The casing may include fabric, vinyl, other polymer or plastic. However, it has been contemplated that a harder material, such as hard plastic or a metal, may form the casing or be included within the casing and positioned between the exterior and interior surfaces. In general, the casing includes six sides and may include a rib 18 disposed along the edge of the casing to provide support. As shown in the figures, the casing also includes rounded edges and has a generally rectangular box shape. In one embodiment, the dimensions of the bag are approximately 7.5 inch×3 inch×3.5 inch. However any dimensions may be used for the locking medicine bag. Further, the locking medicine bag may be in any shape, such as a square box shape, spherical shape, egg-shape, or any other shape.

Having a soft and flexible casing 12 allows users to travel with the locking medicine bag 10, because the flexible casing can easily be packed into a purse, suitcase, or other type of bag. It is preferred that the material of the casing or a lining within the casing is waterproof to better protect the medication being stored in the locking medicine bag.

A zipper 20 is disposed on the casing 12 for opening and closing the locking medicine bag 10. The length of the zipper may cover one, two, or three sides of the casing. The zipper includes zipper tracks 22, with a first half 24 and a second half 26. In the closed configuration shown in FIG. 1, the first and second half of the zipper tracks are engaged together. The zipper also includes an zipper slider 28 having an engaging member 30. In use, the zipper slider runs along the interleaving track of the zipper to open and close the bag.

The zipper 20 also includes a zipper handle 32 having an attaching member 34 at one end that connects with the engaging member 30 of the zipper slider 28. A user pulls the zipper handle to open and close the bag. As best shown in FIG. 2, the zipper handle 32 on one side includes a hook member 36 that extends there from. In one embodiment, the zipper handle and hook member is a single molded piece. Alternatively, the hook member may be molded separately and attached to one side of the zipper handle. The hook member may include an indentation 37 as shown, or in another embodiment, the hook member may instead be an eye member having an open loop.

As shown in FIGS. 1 and 2, the zipper 20 closes the locking medicine bag and locks the bag when used along with a combination lock 38. It is the zipper handle 32 of the zipper that engages the combination lock when the zipper is in a closed configuration. The combination lock is secured or mounted within the locking medicine bag 10 along a wall or side. The combination lock includes a plate 40 that is attached to a frame (not shown), which extends into the casing 12. The plate can be attached to the frame with rivets or other fasteners. In this embodiment, the combination lock includes three combination dials 42 that partially extend out of the plate through individual slots. There is also an actuator 44 disposed on top of the plate and located adjacent to the three combination dials. An engaging slot 46 on the plate of the combination lock exposes a latch member 48 positioned within frame of the combination lock that cooperates with the hook member 36 of the zipper handle 32. In use, when the zipper is in the closed configuration, the indentation 37 on the hook member of the zipper handle receives a portion of the latch member, thereby locking the zipper into position and securing the locking medicine bag.

The combination dials 42 preferably have the configuration shown in FIGS. 1 and 2. Each dial has numerals or other combination characters spaced evenly about the periphery of the dial and each dial has notches located between the successive numerals for engagement with a dial spring (not shown). Each dial may be turned in either direction.

Any existing or known combination lock can be used with the locking medicine bag, so long as the hook member 36 fits within the engaging slot 46 of the plate 40. Generally, to set or change the combination, the actuator 44 is moved to a combination-changing position. In the combination-changing position, the user turns the dials to set the desired combination and then releases the actuator. Additional or different steps may be needed to set the combination depending on the type of combination lock used. To lock the locking medicine bag 10, the user closes the zipper 20 by moving the zipper handle 32, and then places the hook member 36 of the zipper handle into the engaging slot 46. Once the hook member is pushed into the engaging slot 46, the latch member 48 engages the indentation 37 on the hook member, thereby locking the zipper handle in place. The user may also scramble the combination lock by moving the combination dials into a random order. The locking medicine bag remains in the locked configuration shown in FIG. 1 until the user unlocks the combination lock and removes the zipper handle away from the combination lock 38.

To unlock the locking medicine bag 10, the user turns the combination dials 42 to the set combination and then moves the actuator 44, which in turn moves the latch member 48 away from the hook member 36. Once the latch member disengages the hook member, the user may move the zipper handle 32 away from the plate 40 of the combination lock 38 and unzip the bag to gain access to its contents.

In an unlocked and open configuration as shown in FIG. 4, the interior of the locking medicine bag 10 may include elastic straps 50 positioned along the interior surface 16. The elastic straps may be in any position along the interior surface and may also be any size. In one embodiment, one elastic strap is secured to the interior surface at intervals to form individual loops 52. The medicine bottles or containers can by placed within the loops to organize the medicine bottles with the bag. In other embodiments, the loops may vary in size to accommodate medicine bottles of different sizes. Still in another embodiment, no loops may be positioned within the interior of the locking bag, and the user can simply store the medicine bottles within the interior of the bag. Also, pockets may be disposed or sewn into the interior of the casing to organize contents with in the locking medicine bag. The interior surface of the locking medicine bag may be lined with a plastic sheath to easily clean the interior in case of spills and to make the interior of the casing water resistant and/or waterproof. In other embodiments, the interior surface of the locking medicine bag may be covered with cloth or other fabric of any color or pattern.

Thus, it will be understood by those of skill in the art that changes may be made to the present invention, and that changes in its use may also be made, without departing from the spirit of the invention, which is defined in the following claims.

We claim:

1. A locking bag, comprising:
a casing having a partially flexible exterior surface;
a zipper disposed along at least a portion of the casing, the zipper having a zipper slider connected to a zipper track and the zipper slider runs along the zipper track to open and close the zipper, and the zipper having a zipper handle connected to the zipper slider, the zipper handle including a hook member extending from one side of the zipper handle; and
a combination lock secured within the casing;
wherein the hook member of the zipper handle engages the combination lock when the zipper is closed to place the locking bag in a locked configuration.

2. The locking bag of claim 1, further comprising a rib disposed along edges of the casing to provide support to the casing.

3. The locking bag of claim 1, wherein the combination lock includes a plate attached to a frame, and the plate includes a slot that exposes a latch member disposed within the combination lock, and the slot is sized to receive the hook member of the zipper handle, and in the locked configuration the hook member engages the latch member.

4. The locking bag of claim 3, wherein the combination lock includes three combination dials and an actuator to disengage the latch member from the hook member.

5. The locking bag of claim 1, wherein an interior of the casing includes loops to secure objects within the casing.

6. The locking bag of claim 5, wherein the loops are formed with an elastic strap.

7. The locking bag of claim 1, wherein the hook member and the zipper handle are a single molded piece.

8. A locking travel bag, comprising:
a casing having an interior surface and an exterior surface defining an interior area of the casing;
a zipper disposed on the casing having a first half zipper track and a second half zipper track, a zipper slider connected to the first half zipper track and the second half zipper track for engaging and disengaging the first and second half zipper tracks into open and closed configurations;
a zipper handle connected to the zipper slider and the zipper handle including a hook member extending from one side of the zipper handle, and the zipper handle and hook member are a single molded piece; and
a combination lock secured within the casing includes an exterior plate having a slot that exposes a latch member disposed within the combination lock, and the slot is sized to receive the hook member of the zipper handle, and the hook member engages the latch member in a locked configuration.

9. The locking bag of claim 8, further comprising a rib disposed along edges of the casing to provide support to the casing.

10. The locking bag of claim 8, wherein the combination lock includes three combination dials and an actuator to disengage the latch member from the hook member.

11. The locking bag of claim 8, wherein the interior surface of the casing includes loops to secure objects.

12. The locking bag of claim 11, wherein the loops are formed by an elastic strap.

13. The locking bag of claim 8, wherein the zipper must be in the closed configuration for the hook member to engage the latch member in the locked configuration.

14. A locking bag, comprising:
a casing having an interior surface and an exterior surface and the casing having six sides;
a zipper disposed on at least one side of the casing having a first half zipper track and a second half zipper track, a zipper slider connected to the first and second half zipper tracks for engaging and disengaging the first and second half zipper tracks into open and closed configurations;
a zipper handle connected to the zipper slider and the zipper handle including a hook member extending from one side of the zipper handle, and the zipper handle and hook member are a single molded piece; and
a combination lock secured along one side of the casing includes an exterior plate having a slot that exposes a latch member disposed within the combination lock, and the slot is sized to receive the hook member of the zipper handle, and the hook member engages the latch member in a locked configuration when the zipper is in the closed configuration.

15. The locking bag of claim 14, further comprising a rib disposed between the six sides of the casing.

16. The locking bag of claim 14, wherein the combination lock includes three combination dials and an actuator to disengage the latch member from the hook member.

17. The locking bag of claim 14, wherein the interior surface of the casing includes loops to secure objects.

18. The locking bag of claim 17, wherein the loops are formed by an elastic strap.

19. The locking bag of claim 14, wherein the casing is soft and flexible.
